(19) United States
(12) Patent Application Publication
(10) Pub. No.: US 2025/0225721 A1
(43) Pub. Date: Jul. 10, 2025

(54) PERFORMING A THREE-DIMENSIONAL COMPUTER VISION TASK USING A NEURAL RADIANCE FIELD GRID REPRESENTATION OF A SCENE PRODUCED FROM TWO-DIMENSIONAL IMAGES OF AT LEAST A PORTION OF THE SCENE

(71) Applicants: Toyota Research Institute, Inc., Los Altos, CA (US); Georgia Tech Research Corporation, Atlanta, GA (US)

(72) Inventors: Muhammad Zubair Irshad, Milpitas, CA (US); Sergey Zakharov, Menlo Park, CA (US); Vitor Campagnolo Guizilini, Santa Clara, CA (US); Adrien David Gaidon, San Jose, CA (US); Zsolt Kira, Marietta, GA (US); Rares A. Ambrus, San Francisco, CA (US)

(73) Assignees: Toyota Research Institute, Inc., Los Altos, CA (US); Toyota Jidosha Kabushiki Kaisha, Toyota-shi Aichi-ken (JP); Georgia Tech Research Corporation, Atlanta, GA (US)

(21) Appl. No.: 19/010,943

(22) Filed: Jan. 6, 2025

Related U.S. Application Data
(60) Provisional application No. 63/617,446, filed on Jan. 4, 2024.
(60) Provisional application No. 63/565,110, filed on Mar. 14, 2024.

(51) Int. Cl. G06T 15/55; G06T 7/55; G06T 15/00

(52) U.S. Cl. CPC G06T 15/55; G06T 7/55; G06T 15/005; G06T 2207/20084

(57) ABSTRACT

A system for performing a three-dimensional computer vision task using a neural radiance field grid representation of a scene produced from two-dimensional images of at least a portion of the scene can include a processor and a memory. A neural radiance field grid network module can produce, from the two-dimensional images, three-dimensional patches of the neural radiance field grid representation of the scene. A three-dimensional shifted window visual transformer module can produce, from the three-dimensional patches, a feature map. A first decoder module can produce, from the feature map, the neural radiance field grid representation of the scene to train the system. A second decoder module can produce, from the feature map, the neural radiance field grid representation of the scene to perform the three-dimensional computer vision task for a cyber-physical system.

### CROSS-RELATED TO RELATED APPLICATIONS

This application claims the benefit of U.S. Provisional Application No. 63/617,446, filed Jan. 4, 2024, and U.S. Provisional Application No. 63/565,110 filed Mar. 14, 2024, each of which is incorporated herein in its entirety by reference.

### TECHNICAL FIELD

The disclosed technologies are directed to performing a three-dimensional computer vision task using a neural radiance field grid representation of a scene produced from two-dimensional images of at least a portion of the scene.

### BACKGROUND

A cyber-physical system can be an integration of a computer system and a mechanism. The computer system can be configured to monitor or control the mechanism so that one or more interactions between the computer system and one or more physical elements of the mechanism can account for different behavioral modalities or different contexts. Examples of a cyber-physical system can include a robot, an automated vehicle, and the like. Often, a cyber-physical system can include one or more of a sensor system, a perception system, a controller system, an actuator system, or the like. For example, the sensor system can include technologies through which the cyber-physical system can detect objects in an environment of the cyber-physical system. For example, the perception system can perform one or more functions on data about such detected objects (e.g., from the sensor system) to produce information that facilitates a better understanding of the environment. Such functions can include, for example, localization of the cyber-physical system, determination of locations or velocities of the objects, production of an object recognition determination of the objects, or the like. For example, the controller system can use the information from the perception system to determine one or more actions to be performed by the one or more physical elements of the mechanism. For example, the actuator system can receive one or more control signals from the controller system and cause the one or more actions to be performed by the one or more physical elements of the mechanism.

### SUMMARY

In an embodiment, a system for performing a three-dimensional computer vision task using a neural radiance field grid representation of a scene produced from two-dimensional images of at least a portion of the scene can include a processor and a memory. The memory can store a neural radiance field grid network module, a three-dimensional shifted window visual transformer module, and at least one of a first decoder module or a second decoder module. The neural radiance field grid network module can include instructions that, when executed by the processor, cause the processor to produce, from the two-dimensional images, three-dimensional patches of the neural radiance field grid representation of the scene. The three-dimensional shifted window visual transformer module can include instructions that, when executed by the processor, cause the processor to produce, from the three-dimensional patches, a feature map. The first decoder module can include instructions that, when executed by the processor, cause the processor to produce, from the feature map, the neural radiance field grid representation of the scene to train the system. The second decoder module can include instructions that, when executed by the processor, cause the processor to produce, from the feature map, the neural radiance field grid representation of the scene to perform the three-dimensional computer vision task for a cyber-physical system.

In another embodiment, a method for performing a three-dimensional computer vision task using a neural radiance field grid representation of a scene produced from two-dimensional images of at least a portion of the scene can include producing, from the two-dimensional images and by a neural radiance field grid network of a system, three-dimensional patches of the neural radiance field grid representation of the scene. The method can include producing, from the three-dimensional patches and by a three-dimensional shifted windows visual transformer of the system, a feature map. The method can include at least one of: (1) producing, from the feature map and by a first decoder of the system, the neural radiance field grid representation of the scene to train the system or (2) producing, from the feature map and by a second decoder of the system, the neural radiance field grid representation of the scene to perform the three-dimensional computer vision task for a cyber-physical system.

In another embodiment, a non-transitory computer-readable medium for performing a three-dimensional computer vision task using a neural radiance field grid representation of a scene produced from two-dimensional images of at least a portion of the scene can include instructions that, when executed by one or more processors, cause the one or more processors to produce, from the two-dimensional images and by a neural radiance field grid network, three-dimensional patches of the neural radiance field grid representation of the scene. The non-transitory computer-readable medium can include instructions that, when executed by one or more processors, cause the one or more processors to produce, from the three-dimensional patches and by a three-dimensional shifted windows visual transformer, a feature map. The non-transitory computer-readable medium can include at least one of: (1) instructions that, when executed by one or more processors, cause the one or more processors to produce, from the feature map and by a first decoder, the neural radiance field grid representation of the scene to train the system or (2) instructions that, when executed by one or more processors, cause the one or more processors to produce, from the feature map and by a second decoder, the neural radiance field grid representation of the scene to perform the three-dimensional computer vision task for a cyber-physical system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a block diagram that illustrates an example of a system for performing a three-dimensional (3D) computer vision task using a neural radiance field (NeRF) grid representation of a scene produced from two-dimensional (2D) images of at least a portion of the scene, according to the disclosed technologies.

FIG. 2 includes a diagram that illustrates an example of a volume of scene for which cameras can produce 2D images.

FIG. 3 includes examples of the 2D images produced by the cameras illustrated in FIG. 2.

FIG. 4 includes graphs of examples of functions associated with the first camera illustrated in FIG. 2.

FIG. 5 is a diagram that illustrates an example of the NeRF grid representation illustrated in FIG. 1.

FIG. 6 is a diagram that illustrates an example of a downstream internal version of the feature map illustrated in FIG. 1.

FIG. 7 is a diagram that illustrates an example of a modified feature map illustrated in FIG. 1.

FIG. 8 is a diagram that illustrates an example of one or more downstream internal versions of a feature map illustrated in FIG. 1.

FIG. 9 includes a flow diagram that illustrates an example of a method that is associated with performing a 3D computer vision task using a NeRF grid representation of a scene produced from 2D images of at least a portion of the scene, according to the disclosed technologies.

FIG. 10 includes a block diagram that illustrates an example of elements disposed on a vehicle, according to the disclosed technologies.

### DETAILED DESCRIPTION

A perception system of a cyber-physical system can use artificial intelligence (AI) techniques to produce information that facilitates a better understanding of an environment of the cyber-physical system. Often, the cyber-physical system can obtain information about objects in the environment from one or more images of the environment. AI techniques used to process images to extract high-dimensional data to produce numerical or symbolic information, to be used to monitor or control a mechanism of the cyber-physical system, can include computer vision techniques. Examples of tasks performed using computer vision techniques can include image classification, image segmentation, object detection, object recognition, semantic segmentation, semantic labeling, object tracking, and the like. Conventionally, such tasks can be accomplished by convolutional neural networks (CNNs). A CNN can be characterized as an artificial neural network (ANN) that includes convolutional layers and filters that are configured to detect spatial features including, for example, edges, corners, and other characteristics often included in images. More recently, some of these tasks can be accomplished by vision transformers (ViTs), which can perform some of these tasks with greater degrees of accuracy or efficiency than CNNs (e.g., greater average precision (AP), greater average recall (AR), greater peak signal-to-noise ratio (PSNR) etc.).

A ViT can be characterized as a transformer configured for computer vision tasks. In turn, a transformer can be characterized as an ANN configured to process sequences. A transformer can use an attention mechanism to model long-range dependencies in data rather than using recurrent units as are included in a recurrent neural network (RNN). Because transformers can be configured to process sequences, early applications of such transformers have been in fields that include, for example, the development of natural language processing (NLP), the implementation of large language models (LLMs), and the like. For example, a transformer can be configured to operate on tokens, which are a series of numerical representations produced from a text. Likewise, for example, a ViT can be configured to operate on patches, which are a series of numerical representations produced from an image.

A transformer or a ViT can be used to implement an autoencoder. An autoencoder can be an ANN configured to include: (1) an encoder to encode a set of data into a representation and (2) a decoder to decode the representation back into the set of data. An autoencoder can be configured to cause the representation to be efficient. Such an efficient representation can be produced for purposes associated with dimensionality reduction. Because the set of data can be unlabeled, an autoencoder can be used for self-supervised learning. Moreover, an autoencoder can be modified to mask elements of the set of data input into the encoder. (For example, a percentage of the set of data that are masked can be referred to as a mask ratio.) Such an autoencoder can be referred to as a masked autoencoder (MAE). An MAE can be trained to produce an output of a full set of data in response to an input of a portion of the set of data (e.g., the portion that is unmasked). For example, a transformer used to implement an encoder of an MAE can be trained to predict missing words from a text and to produce an output in which these missing words are included in the text. Likewise, for example, a ViT used to implement an encoder of an MAE can be trained to predict missing portions of a representation of scene and to produce an output in which these missing portions are included in the representation of the scene.

However, because operations performed on images, unlike operations performed on text, can have concerns about characteristics that include, for example, scale, resolution, and the like, operations associated with the attention mechanism performed for some computer vision tasks (e.g., object detection, semantic segmentation, or the like) can be sufficiently computationally large that they limit an efficacy of using ViTs for such computer vision tasks.

To address this concern, a ViT architecture can be modified to limit a count of a number of operations associated with the attention mechanism that need to be performed. An example of such a modified ViT architecture can be a shifted window visual transformer (SWIN ViT). A SWIN ViT can partition an image into non-overlapping windows so that operations associated with the attention mechanism are performed within each window rather than on the image as a whole. A SWIN ViT can include an upstream stage and a downstream stage. Boundaries of some of the non-overlapping windows in the downstream stage can overlap boundaries of some of the non-overlapping windows in the upstream stage. In this manner, the SWIN ViT can account for data dependencies that occur outside of the non-overlapping windows in the upstream stage. Additionally, partitioning the image into non-overlapping windows can allow a SWIN ViT to complete operations on high resolution images within a reasonable duration of time. This, in turn, can allow for an architecture that includes a set of SWIN ViTs. The set of SWIN ViTs can include an upstream SWIN ViT and a downstream SWIN ViT. Between the upstream SWIN ViT and the downstream SWIN ViT patches can be merged so that: (1) a count of a number of non-overlapping windows used by the downstream SWIN ViT is less than a count of a number of non-overlapping windows used by the upstream SWIN ViT and (2) a feature map produced by the downstream SWIN ViT can be associated with a smaller degree of resolution than a feature map produced by the upstream SWIN ViT. In this manner the set of SWIN ViTs can produce a set of feature maps of different resolutions.

As stated above, a cyber-physical system can often obtain information about objects in an environment of the cyber-physical system from one or more images of the environment and can use this information to perform a computer vision task. Typically, such one or more images can be one or more two-dimensional (2D) images. However, sometimes the computer vision task can require a three-dimensional (3D) representation of a scene. Unfortunately, often such a 3D representation of a scene can have been produced from data included in one or more 2D images that do not provide a full representation of the scene. To address this concern, the disclosed technologies can use an MAE in which an encoder of the MAE is implemented with a SWIN ViT modified to perform operations on a 3D representation of a scene rather than perform operations on 2D images. Such a modified SWIN ViT can be referred to as a 3D SWIN ViT. Whereas a SWIN ViT can be configured to operate on 2D patches produced from an image, a 3D SWIN ViT can be configured to operate on 3D patches produced from a 3D representation of a scene.

The disclosed technologies can use a neural radiance field (NeRF) network to produce, from data included in one or more 2D images of a scene, a NeRF representation as a 3D representation of the scene. A NeRF network can use: (1) the data included in the one or more 2D images of the scene and (2) information about one or more cameras that produced the one or more 2D images to produce the NeRF representation. For each of the one or more cameras, the information can include: (1) a specific position of the camera with respect to the scene and (2) a specific viewing direction of the camera. A NeRF representation can be defined by functions produced by the NeRF network. Each of the functions can be associated with a corresponding camera. Each of the functions can be of both: (1) values of measurements of color with respect to positions along a ray and (2) values of measurements of density with respect to the positions along the ray. The ray can originate at the corresponding camera and can extend outward from the corresponding camera along an optical axis of the corresponding camera. Collectively, these functions can define the NeRF representation. Because the functions that define the NeRF representation are continuous, the disclosed technologies can sample the functions at discrete positions within a volume that defines the NeRF representation and use values determined at these discrete positions to produce a NeRF grid representation. The disclosed technologies can partition the NeRF grid representation to produce 3D patches.

The disclosed technologies can use, selectively, a first decoder or a second decoder. The first decoder can be a decoder of the MAE and can be used to train a system configured to implement the disclosed technologies. During training, the disclosed technologies can: (1) produce, from one or more 2D images that provide a full representation of a scene, a full NeRF grid representation of the scene, (2) produce, from the full NeRF grid representation of the scene, 3D patches, (3) mask a portion of the 3D patches, (4) input an unmasked portion of the 3D patches to the 3D SWIN ViT, and (4) train the 3D SWIN ViT until the first decoder can produce the full NeRF grid representation of the scene. After the system configured to implement the disclosed technologies has been trained, the second decoder can be used to perform a 3D computer vision task for a cyber-physical system. The second decoder can produce, from one or more 2D images that may not provide a full representation of a different scene, a full NeRF grid representation of the different scene. The full NeRF grid representation of the different scene can be used in a performance of the 3D computer vision task for the cyber-physical system. For example, the 3D computer vision task for the cyber-physical system can include a 3D computer vision task for a control of a motion of the cyber-physical system. For example, the 3D computer vision task can include one or more of: (1) an object detection operation performed on the full NeRF grid representation of the different scene, (2) a semantic labeling operation performed on the full NeRF grid representation of the different scene, (3) a super-resolution imaging operation performed on the full NeRF grid representation of the different scene, or (4) the like.

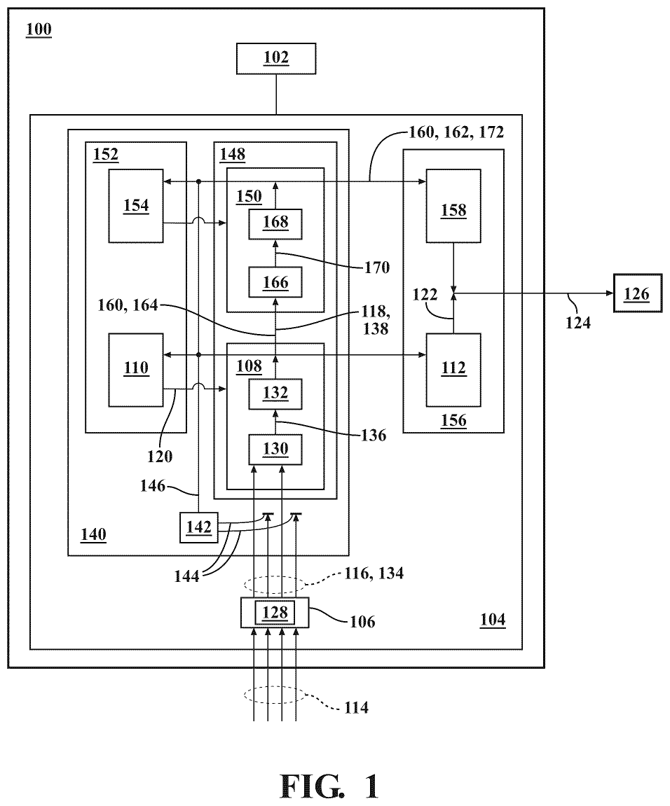

FIG. 1 includes a block diagram that illustrates an example of a system 100 for performing a three-dimensional (3D) computer vision task using a neural radiance field (NeRF) grid representation of a scene produced from two-dimensional (2D) images of at least a portion of the scene, according to the disclosed technologies. The system 100 can include, for example, a processor 102 and a memory 104. The memory 104 can be communicably coupled to the processor 102. For example, the memory 104 can store a neural radiance field (NeRF) grid network module 106, a three-dimensional shifted window visual transformer (3D SWIN ViT) module 108, and one or more of a first decoder module 110 or a second decoder module 112.

For example, the NeRF grid network module 106 can include instructions that function to control the processor 102 to produce, from 2D images 114, three-dimensional (3D) patches 116 of the NeRF grid representation of the scene.

For example, the 3D SWIN ViT module 108 can include instructions that function to control the processor 102 to produce, from the 3D patches 116, a feature map 118.

For example, the first decoder module 110 can include instructions that function to control the processor 102 to produce from, the feature map 118, the NeRF grid representation of the scene 120 to train the system 100.

For example, the second decoder module 112 can include instructions that function to control the processor 102 to produce, from the feature map 118, the NeRF grid representation of the scene 122 to perform the 3D computer vision task 124 for a cyber-physical system 126. For example, the cyber-physical system 126 can include a robot, an automated vehicle, or the like. For example, the 3D computer vision task 124 for the cyber-physical system 126 can include a 3D computer vision task for a control of a motion of the cyber-physical system 126. For example, the 3D computer vision task 124 can include one or more of: (1) an object detection operation performed on the NeRF grid representation of the scene, (2) a semantic labeling operation performed on the NeRF grid representation of the scene, (3) a super-resolution imaging operation performed on the NeRF grid representation of the scene, or (4) the like.

For example, the 2D images 114 can include 2D images produced by cameras. For example, each camera, of the cameras, at a time of a production of a corresponding 2D image, of the 2D images 114 can: (1) be at a specific position with respect to the scene and (2) have a specific viewing direction. For example, the specific position can be defined with respect a 3D Cartesian coordinate system. For example, the specific viewing direction can be defined by a first angle (θ) and a second angle (φ). For example, the first angle (θ) can be between an optical axis of the camera and a first line that intersects the optical axis and an imaging plane of the camera. For example, the first line can be parallel to a specific axis of the 3D Cartesian coordinate system. For example, the specific axis can be a horizontal axis of the 3D Cartesian coordinate system. For example, the second angle (φ) can be between the optical axis and a second line that intersects the optical axis and the imaging plane. For example, the second line can be parallel to a vertical axis of the 3D Cartesian coordinate system.

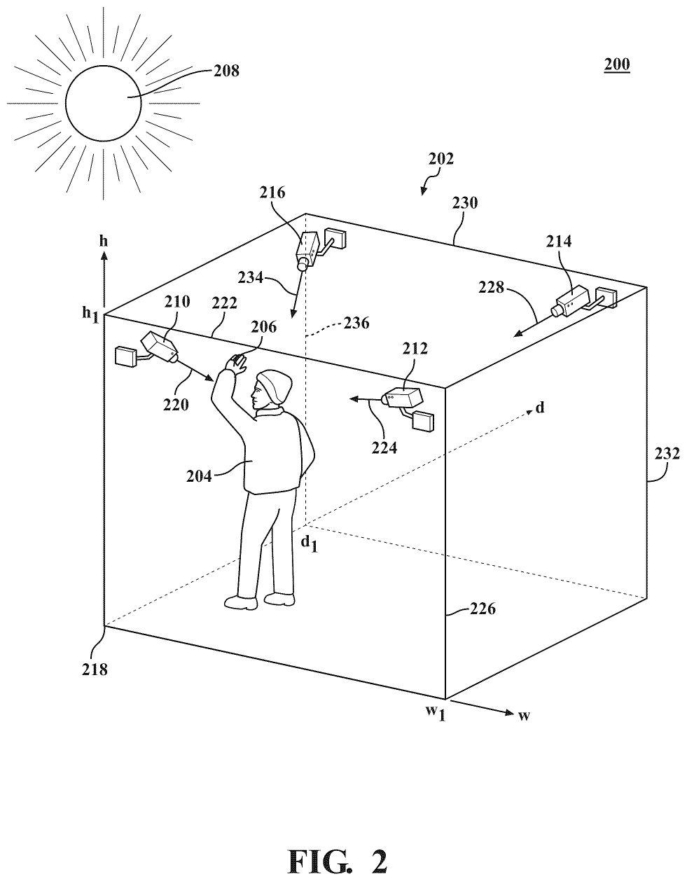

FIG. 2 includes a diagram 200 that illustrates an example of a volume of scene 202 for which cameras can produce 2D images. For example, the scene 202 can include a person 204 holding up a hand 206 to block a light 208. For example, the diagram 200 can include a first camera 210, a second camera 212, a third camera 214, and a fourth camera 216. For example, the diagram 200 can include a 3D Cartesian coordinate system 218 with a height (h) axis, a width (w) axis, and a depth (d) axis. For example, the first camera 210 can be at a position h₁, 0, 0 and can have a viewing direction defined by a first angle (θ), between an optical axis 220 of the first camera 210 and a line 222 that is parallel to the width (w) axis, and a second angle (φ) between the optical axis 220 and the height (h) axis. For example, the second camera 212 can be at a position h₁, w₁, 0 and can have a viewing direction defined by a first angle (θ), between an optical axis 224 of the second camera 212 and the line 222, and a second angle (φ) between the optical axis 224 and a line 226 that is parallel to the height (h) axis. For example, the third camera 214 can be at a position h₁, w₁, d₁ and can have a viewing direction defined by a first angle (θ), between an optical axis 228 of the third camera 214 and a line 230 that is parallel to the width (w) axis, and a second angle (φ) between the optical axis 228 and a line 232 that is parallel to the height (h) axis. For example, the fourth camera 216 can be at a position h₁, 0, d₁ and can have a viewing direction defined by a first angle (θ), between an optical axis 234 of the fourth camera 216 and the line 230, and a second angle (φ) between the optical axis 234 and a line 236 that is parallel to the height (h) axis.

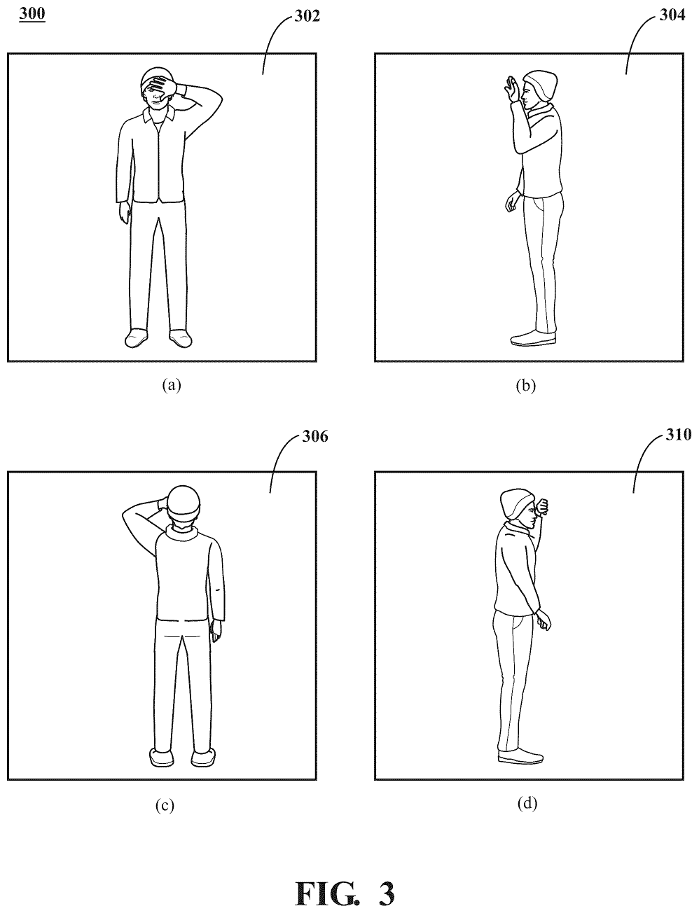

FIG. 3 includes examples 300 of the 2D images produced by the cameras illustrated in FIG. 2. In the examples 300, a view (a) can be an image 302 produced by the first camera 210 illustrated in FIG. 2, a view (b) can be an image 304 produced by the second camera 212 illustrated in FIG. 2, a view (c) can be an image 306 produced by the third camera 214 illustrated in FIG. 2, and a view (d) can be an image 308 produced by the fourth camera 216 illustrated in FIG. 2.

Returning to FIG. 1, for example, the instructions to produce the 3D patches 116 of the NeRF grid representation of the scene, included in the NeRF grid network module 106, can include instructions to produce an initial NeRF representation of the scene. For example, the NeRF grid network module 106 can include a NeRF network 128. For example, the NeRF network 128 can lack a 3D SWIN ViT.

For example, the initial NeRF representation can be defined by functions. For example, each function, of the functions, can be associated with a corresponding camera. For example, each function can be of both: (1) values of measurements of color with respect to positions along a ray and (2) values of measurements of density with respect to the positions along the ray. For example, the ray can originate at an intersection of an optical axis of the corresponding camera and an imaging plane of the corresponding camera. For example, the ray can extend outward from the corresponding camera along the optical axis. With reference to FIG. 2, for example, one or more functions can be associated with the first camera 210 with respect to the positions along the ray 220, one or more functions can be associated with the second camera 212 with respect to the positions along the ray 224, one or more functions can be associated with the third camera 214 with respect to the positions along the ray 234, and one or more functions can be associated with the fourth camera 216 with respect to the positions along the ray 220.

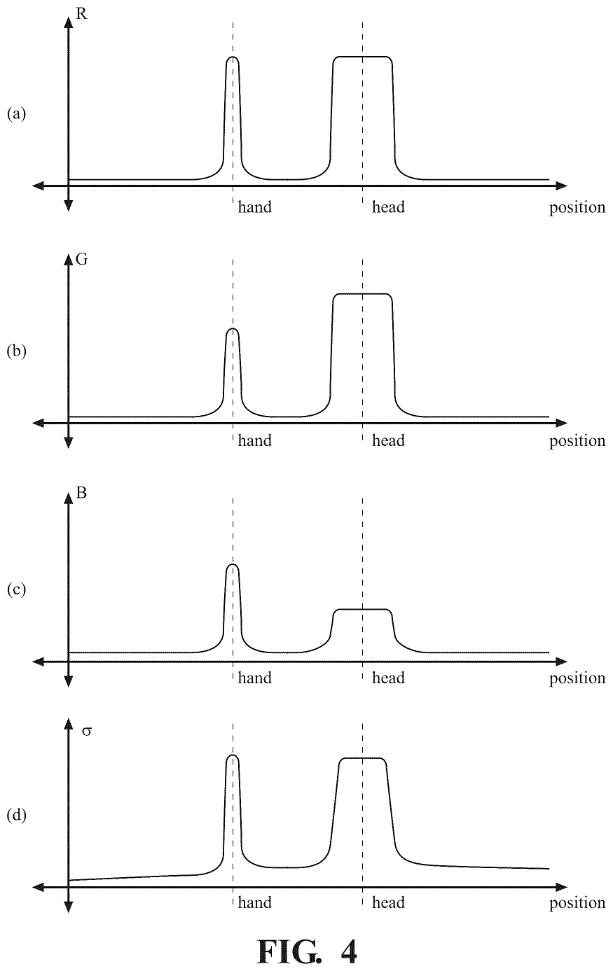

FIG. 4 includes graphs 400 of examples of functions associated with the first camera 210 illustrated in FIG. 2. The graphs 400 can include a graph (a) of values of measurements of the color red (R) with respect to the positions along the ray 220 illustrated in FIG. 2, a graph (b) of values of measurements of the color green (G) with respect to the positions along the ray 220 illustrated in FIG. 2, a graph (c) of values of measurements of the color blue (B) with respect to the positions along the ray 220 illustrated in FIG. 2, and a graph (d) of values of measurements of the density (σ) with respect to the positions along the ray 220 illustrated in FIG. 2. Note that although the ray 220 can be blocked by the hand 206 of the person 204 illustrated in FIG. 2, the NeRF network 128 illustrated in FIG. 1 can use information: (1) in each of the image 302, the image 304, the image 306, and the image 308 illustrated in FIG. 3, (2) about the specific position of each of the first camera 210, the second camera 212, the third camera 214, and the fourth camera 216 illustrated in FIGS. 2, and (3) about the specific viewing direction of each of the first camera 210, the second camera 212, the third camera 214, and the fourth camera 216 illustrated in FIG. 2 to produce the functions associated with the first camera 210 illustrated in FIG. 2 (and corresponding functions associated with each of the second camera 212, the third camera 214, and the fourth camera 216 illustrated in FIG. 2) so that these functions include information with respect to the positions along the ray 220 beyond a position of the hand 206 of the person 204 illustrated in FIG. 2.

Returning to FIG. 1, for example, the instructions to produce the 3D patches 116 of the NeRF grid representation of the scene, included in the NeRF grid network module 106, can include instructions to determine values at discrete positions, within a volume that defines the initial NeRF representation, to produce the NeRF grid representation. For example, the instructions to produce the 3D patches 116 of the NeRF grid representation of the scene can include instructions to uniformly sample the discrete positions within the volume. With reference to FIG. 4, for example, the values at the discrete positions can be determined by sampling the discrete positions for each of the graphs 400. For example, a set of values of a discrete position, of the values at the discrete positions, can include: (1) one or more values of one or more measurements of one or more colors (R, G, and B) at the discrete position and (2) a value of a measurement of a degree of transparency (α) at the discrete position. For example, the set of values can include an average, of all of the 2D images of the scene and for the discrete position, of the values of the measurements of the one or more colors (R, G, and B) and the values of the measurements of the density (σ). For example, the value of the measurement of the degree of transparency (α) can be a value of a difference. The difference can be a value of an exponential function subtracted from one. The exponential function can be an exponential function of a negative of a product. The product can be a product of a constant multiplied by a value of an average, of all of the 2D images of the scene and for the discrete position, of the values of the measurements of the one or more colors (R, G, and B) and the values of the measurement of the density (σ).

Returning to FIG. 1, for example, the instructions to produce the 3D patches 116 of the NeRF grid representation of the scene, included in the NeRF grid network module 106, can include instructions to: (1) partition the NeRF grid representation to produce the 3D patches and (2) embed, for each unmasked 3D patch of the 3D patches, 3D position information about a 3D position of a corresponding unmasked 3D patch, of the 3D patches, within the volume. That is, because a 3D SWIN ViT can be configured to process sequences, embedding, for each unmasked 3D patch, the 3D position information about the 3D position of the corresponding unmasked 3D patch can facilitate having the 3D SWIN ViT perform operations on sequences of 3D patches while maintaining spatial information about the 3D positions of the 3D patches within the volume.

For example, the 3D SWIN ViT module 108 can include an upstream stage module 130 and a downstream stage module 132. For example, the upstream stage module 130 can be configured to partition, into a first set of windows, the NeRF grid representation 134. For example, a window, of the first set of windows, can include one or more 3D patches of the 3D patches. For example, the window, of the first set of windows, can have a shape of a cube. For example, a measurement of a side of the cube can be equal to a cubic root of a count of a number of the one or more 3D patches included in the window. For example, no window, of the first set of windows, can overlap any other window of the first set of windows. For example, the upstream stage module 130 can be configured to: (1) operate a first multi-head self-attention module in which self-attention is computed for each window of the first set of windows and (2) produce a downstream internal version of the feature map 136. For example, the downstream stage module 132 can be configured to partition, into a second set of windows, the downstream internal version of the feature map 136. For example, a window, of the second set of windows, can include one or more 3D patches of the 3D patches. For example, the window, of the second set of windows, can have the shape of the cube. For example, a position of a corner of the window, of the second set of windows, can be a position of a center of the window of the first set of windows. For example, no window, of the second set of windows, can overlap any other window of the second set of windows. For example, a boundary of one or more windows, of the second set of windows, can overlap a boundary of one or more windows of the first set of windows. For example, the downstream stage module 132 can be configured to: (1) operate a second multi-head self-attention module in which self-attention is computed for each window of the second set of windows and (2) produce a 3D SWIN ViT output version of the feature map 138.

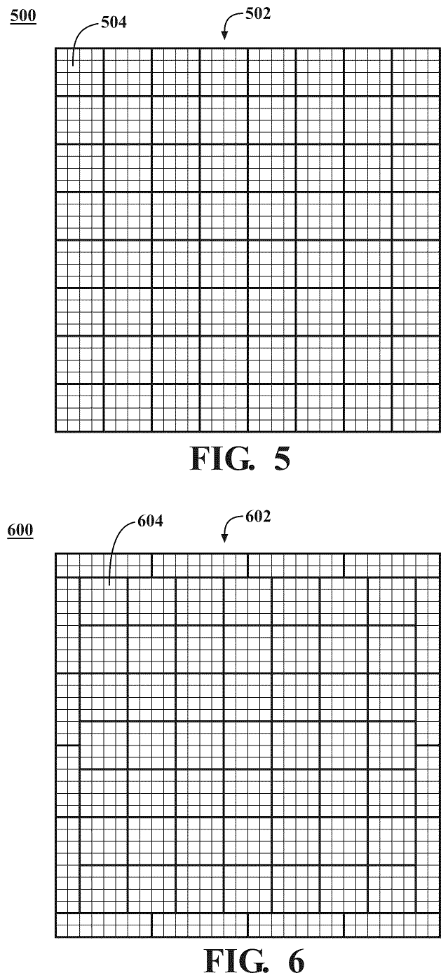

FIG. 5 is a diagram 500 that illustrates an example of the NeRF grid representation 134 illustrated in FIG. 1. Although the illustration of the NeRF grid representation 134 is a 2D illustration, one of skill in the art understands, in light of the description herein, how a 3D illustration of the NeRF grid representation 134 would appear. For example, in the diagram 500, the NeRF grid representation 134 can include 1,024 2D patches (32,768 3D patches) derived from the NeRF grid representation 134. For example, in the diagram 500, the NeRF grid representation 134 can be partitioned into a first set of windows 502. For example, the first set of windows 502 can include 64 2D windows (512 3D windows). For example, a 2D window 504 (3D window 504), of the first set of windows 502, can include 16 2D patches (256 3D patches). For example, the 2D window 504 (3D window 504) can have a shape of a square (cube). For example, a measurement of a side of the square (cube) can be equal to a square (cubic) root of a count of a number of the 16 2D patches (256 3D patches) included in the 2D window 504 (3D window 504). For example, no window, of the first set of windows 502, can overlap any other window of the first set of windows 502.

FIG. 6 is a diagram 600 that illustrates an example of the downstream internal version of the feature map 136 illustrated in FIG. 1. Although the illustration of the downstream internal version of the feature map 136 is a 2D illustration, one of skill in the art understands, in light of the description herein, how a 3D illustration of the downstream internal version of the feature map 136 would appear. For example, in the diagram 600, the downstream internal version of the feature map 136 can include 1,024 2D patches (32,768 3D patches) derived from the downstream internal version of the feature map 136. For example, in the diagram 600, the downstream internal version of the feature map 136 can be partitioned into a second set of windows 602. For example, the second set of windows 602 can include 65 2D windows (e.g., 527 3D windows). For example, a 2D window 604 (3D window 604), of the second set of windows 602, can include 16 2D patches (256 3D patches). For example, the 2D window 604 (3D window 604) can have a shape of a square (cube). For example, a measurement of a side of the square (cube) can be equal to a square (cubic) root of a count of a number of the 16 2D patches (256 3D patches) included in the 2D window 604 (3D window 604). For example, a position of a corner of the 2D window 604 (3D window 604), of the second set of windows 602, can be a position of a center of the 2D window 504 (3D window 504) of the first set of windows 502 illustrated in FIG. 5. For example, no window, of the second set of windows 602, can overlap any other window of the second set of windows 602.

Returning to FIG. 1, for example, the first decoder module 110 can include a voxel decoder module. Alternatively or additionally, for example, the first decoder module 110 can include a transposed convolution decoder module.

Additionally, for example, the memory 104 can further store a mask inserter module 142. For example, the mask inserter module 142 can include instructions that function to control the processor 102 to: (1) mask a portion of the 3D patches to produce masked 3D patches 144 and (2) embed, in the feature map, 3D position information 146 about 3D positions of the masked 3D patches 144. For example, an MAE module 140 can include the mask inserter module 142, the 3D SWIN ViT module 108, and the first decoder module 110. For example, the instructions to produce, from the feature map 118, the NeRF grid representation of the scene to train the system 100, included in the first decoder module 110, can include instructions to produce the NeRF grid representation of the scene, including portions of the scene associated with the masked 3D patches, to train the system 100. For example, the 3D SWIN ViT module 108 and the first decoder module 110 can be trained on a loss function. For example, the loss function can be a sum of a first loss function and a second loss function. For example: (1) the first loss function can be with respect to one or more colors (R, G, and B) and (2) the second loss function can be with respect to a degree of transparency (α). For example, the system 100 can be pretrained from large-scale dataset.

For example, a set of 3D SWIN ViT modules 148 can include the 3D SWIN ViT module 108 and one or more other 3D SWIN ViT modules 150. For example, one or more of: (1) a set of first decoder modules 152 can include the first decoder module 110 and one or more other first decoder modules 154 or (2) a set of second decoder modules 156 can include the second decoder module 112 and one or more other second decoder modules 158. For example, a set of feature maps 160 can include the feature map 118 and one or more other feature maps 162. For example, the 3D SWIN ViT module 108 can be: (1) configured to produce the feature map 118 and (2) connected to the first decoder module 110 or the second decoder module 112 and (2) the one or more other 3D SWIN ViT modules 150 can be: (1) configured to produce the one or more other feature maps 162 and (2) connected to the one or more other first decoder modules 154 or the one or more other second decoder modules 158. For example, the 3D SWIN ViT module 108 can be further configured to: (1) merge a set of the 3D patches, in the feature map 118, into a new single 3D patch to produce a modified feature map 164 and (2) communicate the modified feature map 164 to one of the one or more other 3D SWIN ViT modules 150. For example, discrete positions of the 3D patches, of the set of the 3D patches and within a volume that defines the NeRF grid representation of the scene, can form a shape of a cube. For example: (1) the feature map 118 can be associated with a first degree of resolution, (2) the one or more other feature maps 162 associated with one or more other degrees of resolution, and (3) the first degree of resolution can be larger than the one or more other degrees of resolution.

For example, the one or more other 3D SWIN ViT modules 150 can include one or more other upstream stage modules 166 and one or more other downstream stage modules 168. For example, the one or more other upstream stage modules 166 can be configured to partition, into a first set of windows, the modified feature map 164. For example, a window, of the first set of windows, can include one or more 3D patches of the 3D patches. For example, the window, of the first set of windows, can have a shape of a cube. For example, a measurement of a side of the cube can be equal to a cubic root of a count of a number of the one or more 3D patches included in the window. For example, no window, of the first set of windows, can overlap any other window of the first set of windows. For example, the one or more other upstream stage modules 166 can be configured to: (1) operate a first multi-head self-attention module in which self-attention is computed for each window of the first set of windows and (2) produce one or more downstream internal versions of the feature map 170. For example, the one or more other downstream stage modules 168 can be configured to partition, into a second set of windows, the one or more downstream internal versions of the feature map 170. For example, a window, of the second set of windows, can include one or more 3D patches of the 3D patches. For example, the window, of the second set of windows, can have the shape of the cube. For example, a position of a corner of the window, of the second set of windows, can be a position of a center of the window of the first set of windows. For example, no window, of the second set of windows, can overlap any other window of the second set of windows. For example, a boundary of one or more windows, of the second set of windows, can overlap a boundary of one or more windows of the first set of windows. For example, the one or more other downstream stage modules 168 can be configured to: (1) operate a second multi-head self-attention module in which self-attention is computed for each window of the second set of windows and (2) produce one or more other 3D SWIN ViT output versions of the feature map 172.

For example, the one or more other first decoder modules 154 can include instructions that function to control the processor 102 to produce, from the one or more other 3D SWIN ViT output versions of the feature map 172, one or more other NeRF grid representations of the scene 174 to train the system 100.

For example, the one or more other second decoder modules 158 can include instructions that function to control the processor 102 to produce, from the one or more other 3D SWIN ViT output versions of the feature map 172, one or more other NeRF grid representations of the scene 176 to perform the 3D computer vision task 124 for the cyber-physical system 126.

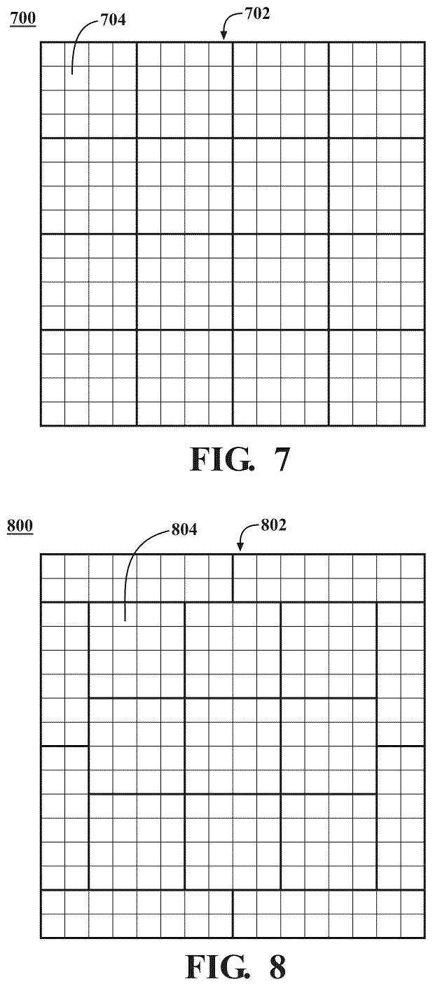

FIG. 7 is a diagram 700 that illustrates an example of the modified feature map 164 illustrated in FIG. 1. Although the illustration of the modified feature map 164 is a 2D illustration, one of skill in the art understands, in light of the description herein, how a 3D illustration of the modified feature map 164 would appear. For example, in the diagram 700, the modified feature map 164 can include 256 2D patches (4,096 3D patches) derived from modified feature map 164. For example, in the diagram 700, the modified feature map 164 can be partitioned into a first set of windows 702. For example, the first set of windows 702 can include 16 2D windows (64 3D windows). For example, a 2D window 704 (3D window 704), of the first set of windows 702, can include 16 2D patches (256 3D patches). For example, the 2D window 704 (3D window 704) can have a shape of a square (cube). For example, a measurement of a side of the square (cube) can be equal to a square (cubic) root of a count of a number of the 16 2D patches (256 3D patches) included in the 2D window 704 (3D window 704). For example, no window, of the first set of windows 702, can overlap any other window of the first set of windows 702.

FIG. 8 is a diagram 800 that illustrates an example of the one or more downstream internal versions of the feature map 170 illustrated in FIG. 1. Although the illustration of the one or more downstream internal versions of the feature map 170 is a 2D illustration, one of skill in the art understands, in light of the description herein, how a 3D illustration of the one or more downstream internal versions of the feature map 170 would appear. For example, in the diagram 800, the one or more downstream internal versions of the feature map 170 can include 256 2D patches (4,096 3D patches) derived from the one or more downstream internal versions of the feature map 170. For example, in the diagram 800, the one or more downstream internal versions of the feature map 170 can be partitioned into a second set of windows 802. For example, the second set of windows 802 can include 17 2D windows (e.g., 73 3D windows). For example, a 2D window 804 (3D window 804), of the second set of windows 802, can include 16 2D patches (256 3D patches). For example, the 2D window 804 (3D window 804) can have a shape of a square (cube). For example, a measurement of a side of the square (cube) can be equal to a square (cubic) root of a count of a number of the 16 2D patches (256 3D patches) included in the 2D window 804 (3D window 804). For example, a position of a corner of the 2D window 804 (3D window 804), of the second set of windows 802, can be a position of a center of the 2D window 704 (3D window 704) of the first set of windows 702 illustrated in FIG. 7. For example, no window, of the second set of windows 802, can overlap any other window of the second set of windows 802.

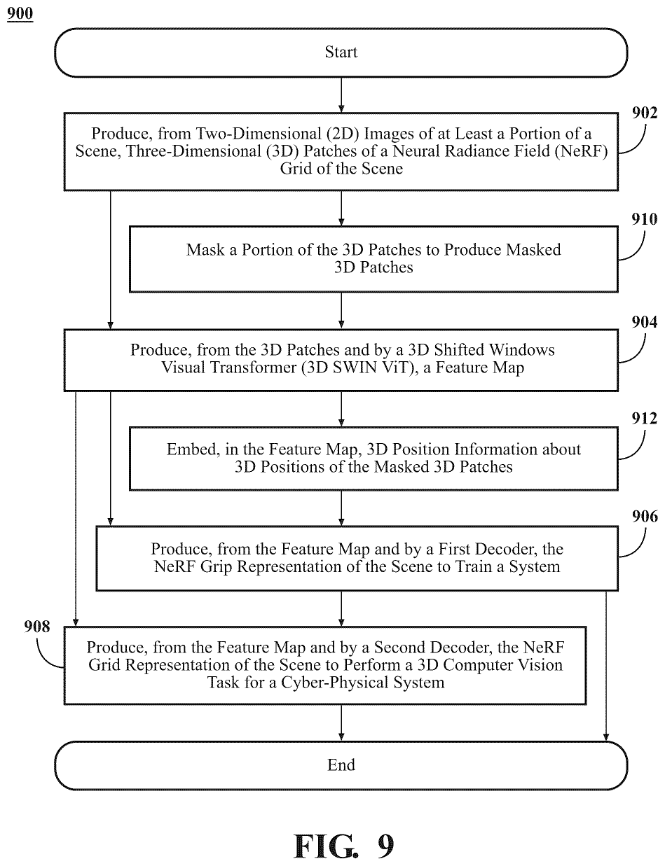

FIG. 9 includes a flow diagram that illustrates an example of a method 900 that is associated with performing a three-dimensional (3D) computer vision task using a neural radiance field (NeRF) grid representation of a scene produced from two-dimensional (2D) images of at least a portion of the scene, according to the disclosed technologies. Although the method 900 is described in combination with the system 100 illustrated in FIG. 1, one of skill in the art understands, in light of the description herein, that the method 900 is not limited to being implemented by the system 100 illustrated in FIG. 1. Rather, the system 100 illustrated in FIG. 1 is an example of a system that may be used to implement the method 900. Additionally, although the method 900 is illustrated as a generally serial process, various aspects of the method 900 may be able to be executed in parallel.

In the method 900, at an operation 902, for example, the NeRF grid network module 106 can produce, from 2D images 114, three-dimensional (3D) patches 116 of the NeRF grid representation of the scene.

At an operation 904, for example, the 3D SWIN ViT module 108 can produce, from the 3D patches 116, a feature map 118.

At an operation 906, for example, the first decoder module 110 can produce from, the feature map 118, the NeRF grid representation of the scene 120 to train the system 100.

At an operation 908, for example, the second decoder module 112 can produce, from the feature map 118, the NeRF grid representation of the scene 122 to perform the 3D computer vision task 124 for the cyber-physical system 126. For example, the cyber-physical system 126 can include a robot, an automated vehicle, or the like. For example, the 3D computer vision task 124 for the cyber-physical system 126 can include a 3D computer vision task for a control of a motion of the cyber-physical system 126. For example, the 3D computer vision task 124 can include one or more of: (1) an object detection operation performed on the NeRF grid representation of the scene, (2) a semantic labeling operation performed on the NeRF grid representation of the scene, (3) a super-resolution imaging operation performed on the NeRF grid representation of the scene, or (4) the like.

For example, the 2D images 114 can include 2D images produced by cameras. For example, each camera, of the cameras, at a time of a production of a corresponding 2D image, of the 2D images 114 can: (1) be at a specific position with respect to the scene and (2) have a specific viewing direction. For example, the specific position can be defined with respect a 3D Cartesian coordinate system. For example, the specific viewing direction is defined by a first angle (θ) and a second angle (φ). For example, the first angle (θ) can be between an optical axis of the camera and a first line that intersects the optical axis and an imaging plane of the camera. For example, the first line can be parallel to a specific axis of the 3D Cartesian coordinate system. For example, the specific axis can be a horizontal axis of the 3D Cartesian coordinate system. For example, the second angle (φ) can be between the optical axis and a second line that intersects the optical axis and the imaging plane. For example, the second line can be parallel to a vertical axis of the 3D Cartesian coordinate system.

For example, the NeRF grid network module 106 can produce an initial NeRF representation of the scene. For example, the NeRF grid network module 106 can include a NeRF network 128. For example, the NeRF network 128 can lack a 3D SWIN ViT.

For example, the initial NeRF representation can be defined by functions. For example, each function, of the functions, can be associated with a corresponding camera. For example, each function can be of both: (1) values of measurements of color with respect to positions along a ray and (2) values of measurements of density with respect to the positions along the ray. For example, the ray can originate at an intersection of an optical axis of the corresponding camera and an imaging plane of the corresponding camera. For example, the ray can extend outward from the corresponding camera along the optical axis.

For example, the NeRF grid network module 106 can determine values at discrete positions, within a volume that defines the initial NeRF representation, to produce the NeRF grid representation. For example, the NeRF grid network module 106 can uniformly sample the discrete positions within the volume. For example, a set of values of a discrete position, of the values at the discrete positions, can include: (1) one or more values of one or more measurements of one or more colors (R, G, and B) at the discrete position and (2) a value of a measurement of a degree of transparency (α) at the discrete position. For example, the set of values can include an average, of all of the 2D images of the scene and for the discrete position, of the values of the measurements of the one or more colors (R, G, and B) and the values of the measurements of the density (σ). For example, the value of the measurement of the degree of transparency (α) can be a value of a difference. The difference can be a value of an exponential function subtracted from one. The exponential function can be an exponential function of a negative of a product. The product can be a product of a constant multiplied by a value of an average, of all of the 2D images of the scene and for the discrete position, of the values of the measurements of the one or more colors (R, G, and B) and the values of the measurement of the density (φ).

For example, the NeRF grid network module 106 can: (1) partition the NeRF grid representation to produce the 3D patches and (2) embed, for each unmasked 3D patch of the 3D patches, 3D position information about a 3D position of a corresponding unmasked 3D patch, of the 3D patches, within the volume.

For example, the 3D SWIN ViT module 108 can include an upstream stage module 130 and a downstream stage module 132. For example, the upstream stage module 130 can be configured to partition, into a first set of windows, the NeRF grid representation 134. For example, a window, of the first set of windows, can include one or more 3D patches of the 3D patches. For example, the window, of the first set of windows, can have a shape of a cube. For example, a measurement of a side of the cube can be equal to a cubic root of a count of a number of the one or more 3D patches included in the window. For example, no window, of the first set of windows, can overlap any other window of the first set of windows. For example, the upstream stage module 130 can be configured to: (1) operate a first multi-head self-attention module in which self-attention is computed for each window of the first set of windows and (2) produce a downstream internal version of the feature map 136. For example, the downstream stage module 132 can be configured to partition, into a second set of windows, the downstream internal version of the feature map 136. For example, a window, of the second set of windows, can include one or more 3D patches of the 3D patches. For example, the window, of the second set of windows, can have the shape of the cube. For example, a position of a corner of the window, of the second set of windows, can be a position of a center of the window of the first set of windows. For example, no window, of the second set of windows, can overlap any other window of the second set of windows. For example, a boundary of one or more windows, of the second set of windows, can overlap a boundary of one or more windows of the first set of windows. For example, the downstream stage module 132 can be configured to: (1) operate a second multi-head self-attention module in which self-attention is computed for each window of the second set of windows and (2) produce a 3D SWIN ViT output version of the feature map 138.

For example, the first decoder module 110 can include a voxel decoder module. Alternatively or additionally, for example, the first decoder module 110 can include a transposed convolution decoder module.

At an operation 910, for example, the mask inserter module 142 can mask a portion of the 3D patches to produce masked 3D patches 144.

At an operation 912, for example, the mask inserter module 142 can embed, in the feature map, 3D position information 146 about 3D positions of the masked 3D patches 144.

For example, an MAE module 140 can include the mask inserter module 142, the 3D SWIN ViT module 108, and the first decoder module 110.

For example, the first decoder module 110 can produce the NeRF grid representation of the scene, including portions of the scene associated with the masked 3D patches, to train the system 100. For example, the 3D SWIN ViT module 108 and the first decoder module 110 can be trained on a loss function. For example, the loss function can be a sum of a first loss function and a second loss function. For example: (1) the first loss function can be with respect to one or more colors (R, G, and B) and (2) the second loss function can be with respect to a degree of transparency (α). For example, the system 100 can be pretrained from large-scale dataset.

For example, a set of 3D SWIN ViT modules 148 can include the 3D SWIN ViT module 108 and one or more other 3D SWIN ViT modules 150. For example, one or more of: (1) a set of first decoder modules 152 can include the first decoder module 110 and one or more other first decoder module 154 or (2) a set of second decoder modules 156 can include the second decoder module 112 and one or more other second decoder modules 158. For example, a set of feature maps 160 can include the feature map 118 and one or more other feature maps 162. For example, the 3D SWIN ViT module 108 can be: (1) configured to produce the feature map 118 and (2) connected to the first decoder module 110 or the second decoder module 112 and (2) the one or more other 3D SWIN ViT modules 150 can be: (1) configured to produce the one or more other feature maps 162 and (2) connected to the one or more other first decoder modules 154 or the one or more other second decoder modules 158. For example, the 3D SWIN ViT module 108 can be further configured to: (1) merge a set of the 3D patches, in the feature map 118, into a new single 3D patch to produce a modified feature map 164 and (2) communicate the modified feature map 164 to one of the one or more other 3D SWIN ViT modules 150. For example, discrete positions of the 3D patches, of the set of the 3D patches and within a volume that defines the NeRF grid representation of the scene, can form a shape of a cube. For example: (1) the feature map 118 can be associated with a first degree of resolution, (2) the one or more other feature maps 162 associated with one or more other degrees of resolution, and (3) the first degree of resolution can be larger than the one or more other degrees of resolution.

For example, the one or more other 3D SWIN ViT modules 150 can include one or more other upstream stage modules 166 and one or more other downstream stage modules 168. For example, the one or more other upstream stage modules 166 can be configured to partition, into a first set of windows, the modified feature map 164. For example, a window, of the first set of windows, can include one or more 3D patches of the 3D patches. For example, the window, of the first set of windows, can have a shape of a cube. For example, a measurement of a side of the cube can be equal to a cubic root of a count of a number of the one or more 3D patches included in the window. For example, no window, of the first set of windows, can overlap any other window of the first set of windows. For example, the one or more other upstream stage modules 166 can be configured to: (1) operate a first multi-head self-attention module in which self-attention is computed for each window of the first set of windows and (2) produce one or more downstream internal versions of the feature map 170. For example, the one or more other downstream stage modules 168 can be configured to partition, into a second set of windows, the one or more downstream internal versions of the feature map 170. For example, a window, of the second set of windows, can include one or more 3D patches of the 3D patches. For example, the window, of the second set of windows, can have the shape of the cube. For example, a position of a corner of the window, of the second set of windows, can be a position of a center of the window of the first set of windows. For example, no window, of the second set of windows, can overlap any other window of the second set of windows. For example, a boundary of one or more windows, of the second set of windows, can overlap a boundary of one or more windows of the first set of windows. For example, the one or more other downstream stage modules 168 can be configured to: (1) operate a second multi-head self-attention module in which self-attention is computed for each window of the second set of windows and (2) produce one or more other 3D SWIN ViT output versions of the feature map 172.

For example, the one or more other first decoder modules 154 can produce, from the one or more other 3D SWIN ViT output versions of the feature map 172, one or more other NeRF grid representations of the scene 174 to train the system 100.

For example, the one or more other second decoder modules 158 can produce, from the one or more other 3D SWIN ViT output versions of the feature map 172, one or more other NeRF grid representations of the scene 176 to perform the 3D computer vision task 124 for the cyber-physical system 126.

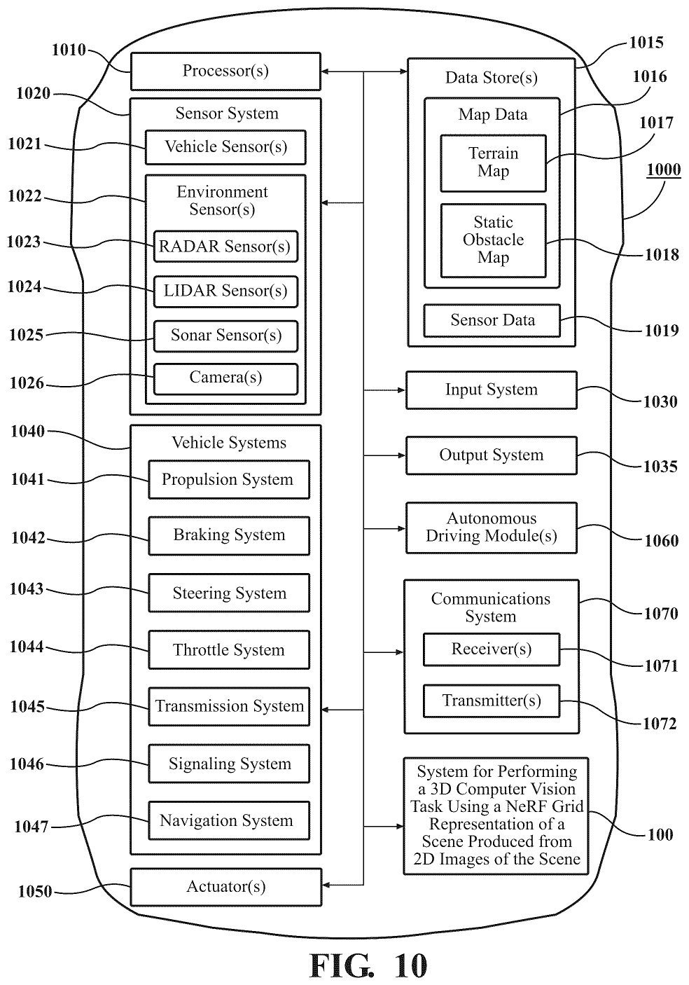

FIG. 10 includes a block diagram that illustrates an example of elements disposed on a vehicle 1000, according to the disclosed technologies. As used herein, a “vehicle” can be any form of powered transport. In one or more implementations, the vehicle 1000 can be an automobile. While arrangements described herein are with respect to automobiles, one of skill in the art understands, in light of the description herein, that embodiments are not limited to automobiles. For example, functions and/or operations of the cyber-physical system 126 (illustrated in FIG. 1) can be realized by the vehicle 1000.

In some embodiments, the vehicle 1000 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 1000 is performed according to inputs received from a user (e.g., human driver). In one or more arrangements, the vehicle 1000 can be a conventional vehicle that is configured to operate in only a manual mode.

In one or more embodiments, the vehicle 1000 can be an automated vehicle. As used herein, “automated vehicle” can refer to a vehicle that operates in an automated mode. As used herein, “automated mode” can refer to navigating and/or maneuvering the vehicle 1000 along a travel route using one or more computing systems to control the vehicle 1000 with minimal or no input from a human driver. In one or more embodiments, the vehicle 1000 can be highly automated or completely automated. In one embodiment, the vehicle 1000 can be configured with one or more semi-automated operational modes in which one or more computing systems perform a portion of the navigation and/or maneuvering of the vehicle along a travel route, and a vehicle operator (i.e., driver) provides inputs to the vehicle 1000 to perform a portion of the navigation and/or maneuvering of the vehicle 1000 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 1000 can include various elements. The vehicle 1000 can have any combination of the various elements illustrated in FIG. 10. In various embodiments, it may not be necessary for the vehicle 1000 to include all of the elements illustrated in FIG. 10. Furthermore, the vehicle 1000 can have elements in addition to those illustrated in FIG. 10. While the various elements are illustrated in FIG. 10 as being located within the vehicle 1000, one or more of these elements can be located external to the vehicle 1000. Furthermore, the elements illustrated may be physically separated by large distances. For example, as described, one or more components of the disclosed system can be implemented within the vehicle 1000 while other components of the system can be implemented within a cloud-computing environment, as described below. For example, the elements can include one or more processors 1010, one or more data stores 1015, a sensor system 1020, an input system 1030, an output system 1035, vehicle systems 1040, one or more actuators 1050, one or more automated driving modules 1060, a communications system 1070, and the system 100 for producing a neural radiance field (NeRF) grid representation of a scene from two-dimensional (2D) images of the scene.

In one or more arrangements, the one or more processors 1010 can be a main processor of the vehicle 1000. For example, the one or more processors 1010 can be an electronic control unit (ECU). For example, functions and/or operations of the processor 102 (illustrated in FIG. 1) can be realized by the one or more processors 1010.

The one or more data stores 1015 can store, for example, one or more types of data. The one or more data stores 1015 can include volatile memory and/or non-volatile memory. Examples of suitable memory for the one or more data stores 1015 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 1015 can be a component of the one or more processors 1010. Additionally or alternatively, the one or more data stores 1015 can be operatively connected to the one or more processors 1010 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of one or more of the memory 104 (illustrated in FIG. 1) can be realized by the one or more data stores 1015.

In one or more arrangements, the one or more data stores 1015 can store map data 1016. The map data 1016 can include maps of one or more geographic areas. In some instances, the map data 1016 can include information or data on roads, traffic control devices, road markings, structures, features, and/or landmarks in the one or more geographic areas. The map data 1016 can be in any suitable form. In some instances, the map data 1016 can include aerial views of an area. In some instances, the map data 1016 can include ground views of an area, including 360-degree ground views. The map data 1016 can include measurements, dimensions, distances, and/or information for one or more items included in the map data 1016 and/or relative to other items included in the map data 1016. The map data 1016 can include a digital map with information about road geometry. The map data 1016 can be high quality and/or highly detailed.

In one or more arrangements, the map data 1016 can include one or more terrain maps 1017. The one or more terrain maps 1017 can include information about the ground, terrain, roads, surfaces, and/or other features of one or more geographic areas. The one or more terrain maps 1017 can include elevation data of the one or more geographic areas. The map data 1016 can be high quality and/or highly detailed. The one or more terrain maps 1017 can define one or more ground surfaces, which can include paved roads, unpaved roads, land, and other things that define a ground surface.

In one or more arrangements, the map data 1016 can include one or more static obstacle maps 1018. The one or more static obstacle maps 1018 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 1018 can have location data, size data, dimension data, material data, and/or other data associated with them. The one or more static obstacle maps 1018 can include measurements, dimensions, distances, and/or information for one or more static obstacles. The one or more static obstacle maps 1018 can be high quality and/or highly detailed. The one or more static obstacle maps 1018 can be updated to reflect changes within a mapped area.

In one or more arrangements, the one or more data stores 1015 can store sensor data 1019. As used herein, “sensor data” can refer to any information about the sensors with which the vehicle 1000 can be equipped including the capabilities of and other information about such sensors. The sensor data 1019 can relate to one or more sensors of the sensor system 1020. For example, in one or more arrangements, the sensor data 1019 can include information about one or more lidar sensors 1024 of the sensor system 1020.

In some arrangements, at least a portion of the map data 1016 and/or the sensor data 1019 can be located in one or more data stores 1015 that are located onboard the vehicle 1000. Additionally or alternatively, at least a portion of the map data 1016 and/or the sensor data 1019 can be located in one or more data stores 1015 that are located remotely from the vehicle 1000.

The sensor system 1020 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 1020 includes a plurality of sensors, the sensors can work independently from each other. Alternatively, two or more of the sensors can work in combination with each other. In such a case, the two or more sensors can form a sensor network. The sensor system 1020 and/or the one or more sensors can be operatively connected to the one or more processors 1010, the one or more data stores 1015, and/or another element of the vehicle 1000 (including any of the elements illustrated in FIG. 10). The sensor system 1020 can acquire data of at least a portion of the external environment of the vehicle 1000 (e.g., nearby vehicles). The sensor system 1020 can include any suitable type of sensor. Various examples of different types of sensors are described herein. However, one of skill in the art understands that the embodiments are not limited to the particular sensors described herein.

The sensor system 1020 can include one or more vehicle sensors 1021. The one or more vehicle sensors 1021 can detect, determine, and/or sense information about the vehicle 1000 itself. In one or more arrangements, the one or more vehicle sensors 1021 can be configured to detect and/or sense position and orientation changes of the vehicle 1000 such as, for example, based on inertial acceleration. In one or more arrangements, the one or more vehicle sensors 1021 can include one or more accelerometers, one or more gyroscopes, an inertial measurement unit (IMU), a dead-reckoning system, a global navigation satellite system (GNSS), a global positioning system (GPS), a navigation system 1047, and/or other suitable sensors. The one or more vehicle sensors 1021 can be configured to detect and/or sense one or more characteristics of the vehicle 1000. In one or more arrangements, the one or more vehicle sensors 1021 can include a speedometer to determine a current speed of the vehicle 1000.

Additionally or alternatively, the sensor system 1020 can include one or more environment sensors 1022 configured to acquire and/or sense driving environment data. As used herein, “driving environment data” can include data or information about the external environment in which a vehicle is located or one or more portions thereof. For example, the one or more environment sensors 1022 can be configured to detect, quantify, and/or sense obstacles in at least a portion of the external environment of the vehicle 1000 and/or information/data about such obstacles. Such obstacles may be stationary objects and/or dynamic objects. The one or more environment sensors 1022 can be configured to detect, measure, quantify, and/or sense other things in the external environment of the vehicle 1000 such as, for example, lane markers, signs, traffic lights, traffic signs, lane lines, crosswalks, curbs proximate the vehicle 1000, off-road objects, etc.

Various examples of sensors of the sensor system 1020 are described herein. The example sensors may be part of the one or more vehicle sensors 1021 and/or the one or more environment sensors 1022. However, one of skill in the art understands that the embodiments are not limited to the particular sensors described.

In one or more arrangements, the one or more environment sensors 1022 can include one or more radar sensors 1023, one or more lidar sensors 1024, one or more sonar sensors 1025, and/or one more cameras 1026. In one or more arrangements, the one or more cameras 1026 can be one or more high dynamic range (HDR) cameras or one or more infrared (IR) cameras. For example, the one or more cameras 1026 can be used to record a reality of a state of an item of information that can appear in the digital map. For example, functions and/or operations of one or more of the first camera 210 (illustrated in FIG. 2), the second camera 212 (illustrated in FIG. 2), the third camera 214 (illustrated in FIG. 2), and a fourth camera 216 (illustrated in FIG. 2) can be realized by the one or more cameras 1026.

The input system 1030 can include any device, component, system, element, arrangement, or groups thereof that enable information/data to be entered into a machine. The input system 1030 can receive an input from a vehicle passenger (e.g., a driver or a passenger). The output system 1035 can include any device, component, system, element, arrangement, or groups thereof that enable information/data to be presented to a vehicle passenger (e.g., a driver or a passenger).

Various examples of the one or more vehicle systems 1040 are illustrated in FIG. 10. However, one of skill in the art understands that the vehicle 1000 can include more, fewer, or different vehicle systems. Although particular vehicle systems can be separately defined, each or any of the systems or portions thereof may be otherwise combined or segregated via hardware and/or software within the vehicle 1000. For example, the one or more vehicle systems 1040 can include a propulsion system 1041, a braking system 1042, a steering system 1043, a throttle system 1044, a transmission system 1045, a signaling system 1046, and/or the navigation system 1047. Each of these systems can include one or more devices, components, and/or a combination thereof, now known or later developed.

The navigation system 1047 can include one or more devices, applications, and/or combinations thereof, now known or later developed, configured to determine the geographic location of the vehicle 1000 and/or to determine a travel route for the vehicle 1000. The navigation system 1047 can include one or more mapping applications to determine a travel route for the vehicle 1000. The navigation system 1047 can include a global positioning system, a local positioning system, a geolocation system, and/or a combination thereof.

The one or more actuators 1050 can be any element or combination of elements operable to modify, adjust, and/or alter one or more of the vehicle systems 1040 or components thereof responsive to receiving signals or other inputs from the one or more processors 1010 and/or the one or more automated driving modules 1060. Any suitable actuator can be used. For example, the one or more actuators 1050 can include motors, pneumatic actuators, hydraulic pistons, relays, solenoids, and/or piezoelectric actuators.

The one or more processors 1010 and/or the one or more automated driving modules 1060 can be operatively connected to communicate with the various vehicle systems 1040 and/or individual components thereof. For example, the one or more processors 1010 and/or the one or more automated driving modules 1060 can be in communication to send and/or receive information from the various vehicle systems 1040 to control the movement, speed, maneuvering, heading, direction, etc. of the vehicle 1000. The one or more processors 1010 and/or the one or more automated driving modules 1060 may control some or all of these vehicle systems 1040 and, thus, may be partially or fully automated.

The one or more processors 1010 and/or the one or more automated driving modules 1060 may be operable to control the navigation and/or maneuvering of the vehicle 1000 by controlling one or more of the vehicle systems 1040 and/or components thereof. For example, when operating in an automated mode, the one or more processors 1010 and/or the one or more automated driving modules 1060 can control the direction and/or speed of the vehicle 1000. The one or more processors 1010 and/or the one or more automated driving modules 1060 can cause the vehicle 1000 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 1070 can include one or more receivers 1071 and/or one or more transmitters 1072. The communications system 1070 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 1070 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 1010, the one or more data stores 1015, and the communications system 1070 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 1000 can include one or more modules, at least some of which are described herein. The modules can be implemented as computer-readable program code that, when executed by the one or more processors 1010, implement one or more of the various processes described herein. One or more of the modules can be a component of the one or more processors 1010. Additionally or alternatively, one or more of the modules can be executed on and/or distributed among other processing systems to which the one or more processors 1010 can be operatively connected. The modules can include instructions (e.g., program logic) executable by the one or more processors 1010. Additionally or alternatively, the one or more data store 1015 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 1000 can include one or more automated driving modules 1060. The one or more automated driving modules 1060 can be configured to receive data from the sensor system 1020 and/or any other type of system capable of capturing information relating to the vehicle 1000 and/or the external environment of the vehicle 1000. In one or more arrangements, the one or more automated driving modules 1060 can use such data to generate one or more driving scene models. The one or more automated driving modules 1060 can determine position and velocity of the vehicle 1000. The one or more automated driving modules 1060 can determine the location of obstacles, obstacles, or other environmental features including traffic signs, trees, shrubs, neighboring vehicles, pedestrians, etc.

The one or more automated driving modules 1060 can be configured to receive and/or determine location information for obstacles within the external environment of the vehicle 1000 for use by the one or more processors 1010 and/or one or more of the modules described herein to estimate position and orientation of the vehicle 1000, vehicle position in global coordinates based on signals from a plurality of satellites, or any other data and/or signals that could be used to determine the current state of the vehicle 1000 or determine the position of the vehicle 1000 with respect to its environment for use in either creating a map or determining the position of the vehicle 1000 in respect to map data.

The one or more automated driving modules 1060 can be configured to determine one or more travel paths, current automated driving maneuvers for the vehicle 1000, future automated driving maneuvers and/or modifications to current automated driving maneuvers based on data acquired by the sensor system 1020, driving scene models, and/or data from any other suitable source such as determinations from the sensor data 1019. As used herein, “driving maneuver” can refer to one or more actions that affect the movement of a vehicle. Examples of driving maneuvers include: accelerating, decelerating, braking, turning, moving in a lateral direction of the vehicle 1000, changing travel lanes, merging into a travel lane, and/or reversing, just to name a few possibilities. The one or more automated driving modules 1060 can be configured to implement determined driving maneuvers. The one or more automated driving modules 1060 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 1060 can be configured to execute various vehicle functions and/or to transmit data to, receive data from, interact with, and/or control the vehicle 1000 or one or more systems thereof (e.g., one or more of vehicle systems 1040). For example, functions and/or operations of an automotive navigation system can be realized by the one or more automated driving modules 1060.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-10, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™M, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
a neural radiance field grid network module including instructions that, when executed by the processor, cause the processor to produce, from two-dimensional images of at least a portion of a scene, three-dimensional patches of a neural radiance field grid representation of the scene;
a three-dimensional shifted window visual transformer module including instructions that, when executed by the processor, cause the processor to produce, from the three-dimensional patches, a feature map; and
at least one of:
a first decoder module including instructions that, when executed by the processor, cause the processor to produce, from the feature map, the neural radiance field grid representation of the scene to train the system, or
a second decoder module including instructions that, when executed by the processor, cause the processor to produce, from the feature map, the neural radiance field grid representation of the scene to perform a three-dimensional computer vision task for a cyber-physical system.

2. The system of claim 1, wherein:
the three-dimensional shifted window visual transformer module comprises an upstream stage module and a downstream stage module,
the upstream stage module is configured to partition, into a first set of windows, at least one of the neural radiance field grid representation or an upstream internal version of the feature map,
a window, of the first set of windows, includes at least one three-dimensional patch of the three-dimensional patches,
no window, of the first set of windows, overlaps any other window of the first set of windows,
the upstream stage module is configured to:
operate a first multi-head self-attention module in which self-attention is computed for each window of the first set of windows, and
produce a downstream internal version of the feature map,
the downstream stage module is configured to partition, into a second set of windows, the downstream version of the feature map,
a window, of the second set of windows, includes at least one three-dimensional patch of the three-dimensional patches,
no window, of the second set of windows, overlaps any other window of the second set of windows,
a boundary of at least one window, of the second set of windows, overlaps a boundary of at least one window of the first set of windows, and
the downstream stage module is configured to:
operate a second multi-head self-attention module in which self-attention is computed for each window of the second set of windows, and
produce a three-dimensional shifted window visual transformer output version of the feature map.

3. The system of claim 2, wherein:
the window, of the first set of windows, has a shape of a cube,
a measurement of a side of the cube is equal to a cubic root of a count of a number of the at least one three-dimensional patch included in the window,
the window, of the second set of windows, has the shape of the cube, and
a position of a corner of the window, of the second set of windows, is a position of a center of the window of the first set of windows.

4. The system of claim 1, wherein:
the neural radiance field grid network module includes a neural radiance field network, and
the neural radiance field network lacks a three-dimensional shifted window visual transformer.

5. The system of claim 1, wherein:
the two-dimensional images comprise two-dimensional images produced by cameras,
each camera, of the cameras, at a time of a production of a corresponding two-dimensional image, of the two-dimensional images:
is at a specific position with respect to the scene, and
has a specific viewing direction, and
the instructions to produce the three-dimensional patches of the neural radiance field grid representation of the scene include instructions to:
produce an initial neural radiance field representation of the scene,
determine values at discrete positions, within a volume that defines the initial neural radiance field representation, to produce the neural radiance field grid representation,
partition the neural radiance field grid representation to produce the three-dimensional patches, and
embed, for each unmasked three-dimensional patch of the three-dimensional patches, three-dimensional position information about a three-dimensional position of a corresponding unmasked three-dimensional patch, of the three-dimensional patches, within the volume.

6. The system of claim 5, wherein the instructions to produce the three-dimensional patches further include instructions to uniformly sample the discrete positions within the volume.

7. The system of claim 5, wherein:
the initial neural radiance field representation is defined by functions,
each function, of the functions, is associated with a corresponding camera and is of both:
values of measurements of color with respect to positions along a ray, and
values of measurements of density with respect to the positions along the ray,
the ray originates at an intersection of an optical axis of the corresponding camera and an imaging plane of the corresponding camera,
the ray extends outward from the corresponding camera along the optical axis, and
a set of values of a discrete position, of the values at the discrete positions, comprises:
at least one value of at least one measurement of at least one color at the discrete position, and
a value of a measurement of a degree of transparency at the discrete position.

8. The system of claim 7, wherein:
the value of the measurement of the degree of transparency is a value of a difference,
the difference is a value of an exponential function subtracted from one,
the exponential function is an exponential function of a negative of a product, and
the product is a product of a constant multiplied by a value of an average, of all of the two-dimensional images of the scene and for the discrete position, of the values of the measurements of the at least one color and the values of the measurement of the density.

9. The system of claim 7, wherein:
the memory further stores a mask inserter module including instructions that, when executed by the processor, cause the processor to:
mask a portion of the three-dimensional patches to produce masked three-dimensional patches; and
embed, in the feature map, three-dimensional position information about three-dimensional positions of the masked three-dimensional patches, and
the instructions to produce, from the feature map, the neural radiance field grid representation of the scene to train the system include instructions to produce the neural radiance field grid representation of the scene, including portions of the scene associated with the masked three-dimensional patches, to train the system.

10. The system of claim 9, wherein the first decoder module comprises at least one of a voxel decoder module or a transposed convolution decoder module.

11. The system of claim 9, wherein a masked autoencoder module comprises the mask inserter module, the three-dimensional shifted window visual transformer module, and the first decoder module.

12. The system of claim 9, wherein:
the three-dimensional shifted window visual transformer module and the first decoder module are trained on a loss function,
the loss function is a sum of a first loss function and a second loss function,
the first loss function is with respect to at least one color, and
the second loss function is with respect to a degree of transparency.

13. The system of claim 1, wherein:
a set of three-dimensional shifted windows visual transformer modules comprises the three-dimensional shifted windows visual transformer module and at least one other three-dimensional shifted windows visual transformer module,
at least one of:
a set of first decoder modules comprises the first decoder module and at least one other first decoder module, or
a set of second decoder modules comprises the second decoder module and at least one other second decoder module,
a set of feature maps comprises the feature map and at least one other feature map,
the three-dimensional shifted windows visual transformer module is:
configured to produce the feature map, and
connected to the first decoder module or the second decoder module, and
the at least one other three-dimensional shifted windows visual transformer module is:
configured to produce the at least one other feature map, and
connected to the at least one other first decoder module or the at least one other second decoder module.

14. The system of claim 13, wherein:
the three-dimensional shifted windows visual transformer module is further configured to:
merge a set of the three-dimensional patches, in the feature map, into a new single three-dimensional patch to produce a modified feature map; and
communicate the modified feature map to one of the at least one other three-dimensional shifted windows visual transformer modules, and
discrete positions of the three-dimensional patches, of the set of the three-dimensional patches and within a volume that defines the neural radiance field grid representation of the scene, form a shape of a cube.

15. The system of claim 13, wherein:
the feature map is associated with a first degree of resolution,
the at least one other feature map is associated with at least one other degree of resolution, and
the first degree of resolution is larger than the at least one other degree of resolution.

16. The system of claim 1, wherein the cyber-physical system comprises at least one of a robot or an automated vehicle.

17. A method, comprising:
producing, from two-dimensional images of at least a portion of a scene and by a neural radiance field grid network of a system, three-dimensional patches of a neural radiance field grid representation of the scene;
producing, from the three-dimensional patches and by a three-dimensional shifted window visual transformer of the system, a feature map; and
at least one of producing, from the feature map, the neural radiance field grid representation,
by a first decoder of the system to train the system, or
by a second decoder of the system to perform a three-dimensional computer vision task for a cyber-physical system.

18. The method of claim 17, wherein the three-dimensional computer vision task for the cyber-physical system comprises a three-dimensional computer vision task for a control of a motion of the cyber-physical system.

19. The method of claim 17, wherein the three-dimensional computer vision task comprises at least one of:
an object detection operation performed on the neural radiance field grid representation of the scene,
a semantic labeling operation performed on the neural radiance field grid representation of the scene, or
a super-resolution imaging operation performed on the neural radiance field grid representation of the scene.

20. A non-transitory computer-readable medium for performing a three-dimensional computer vision task using a neural radiance field grid representation of a scene produced from two-dimensional images of at least a portion of the scene, the non-transitory computer-readable medium including instructions that, when executed by one or more processors, cause the one or more processors to:
produce, from the two-dimensional images and by a neural radiance field grid network, three-dimensional patches of the neural radiance field grid representation of the scene;
produce, from the three-dimensional patches and by a three-dimensional shifted windows visual transformer, a feature map; and
at least one of produce, from the feature map, the neural radiance field grid representation of the scene,
by a first decoder to train the system, or
by a second decoder to perform the three-dimensional computer vision task for a cyber-physical system.
